(19) United States
(12) Patent Application Publication
(10) Pub. No.: US 2026/0282122 A1
(43) Pub. Date: Sep. 17, 2026

(54) Methods And Systems For Operating A Wireless Industrial Edge Cloud System Comprising One Or More Base Stations

(71) Applicant: Siemens Aktiengesellschaft, München (DE)

(72) Inventors: Florian Zeiger, Garching (DE); Markus Sauer, Garching (DE)

(73) Assignee: Siemens Aktiengesellschaft, München (DE)

(21) Appl. No.: 19/167,437

(22) PCT Filed: Mar. 21, 2024
(86) PCT No.: PCT/EP2024/057524

§ 371 Date: Sep. 22, 2025

(30) Foreign Application Priority Data
Mar. 27, 2023 (EP) 23164247.1
May 31, 2023 (DE) 10 2023 205 078.1

(51) Int. Cl. H04W 76/10; H04W 12/06; H04W 88/04; H04W 88/06

(52) U.S. Cl. CPC H04W 76/10; H04W 12/06; H04W 88/04; H04W 88/06

(57) ABSTRACT

Various embodiments of the teachings herein include a method for operating a wireless industrial edge cloud system with a first radio base station. An example includes: setting up a communication link between the first radio base station and a terminal; and using the terminal as an additional second radio base station.

### CROSS-REFERENCE TO RELATED APPLICATIONS

This application a U.S. National Stage Application of International Application No. PCT/EP2024/057524 filed Mar. 21, 2024, which designates the United States of America, and claims priority to DE Application No. 10 2023 205 078.1 filed May 31, 2023 and EP Application No. 23164247.1 filed Mar. 27, 2023, the contents of which are hereby incorporated by reference in their entirety.

### TECHNICAL FIELD

The present disclosure relates wireless industrial edge cloud systems. Various embodiments of the teachings herein include systems and/or methods for operating a wireless industrial edge cloud system comprising one or more radio base stations

### BACKGROUND

Wireless communication systems such as 5G or future 6G systems have been developed to use cloud technologies for better scalability. However, such communication systems have a defined and restricted coverage. Numerous industrial applications, in particular in the case of large construction sites, require extensive coverage. One application case is for instance motorway roadworks in which radio units, such as antennas or radio devices or communication devices, have to be installed temporarily. A wired link between such radio units is generally not possible or not desirable. Proprietary directional wireless links are therefore often typically installed in order to provide a bridge between the antennas.

There is thus a need to modify future edge cloud systems, such as in particular 5G and 6G systems, so as to enable demand-oriented extension of coverage with their own integral technological components.

### SUMMARY

The teachings of the present disclosure include improved methods and/or systems for operating a wireless industrial edge cloud system comprising one or more radio base stations. For example, some embodiments include a method for operating a wireless industrial edge cloud system comprising at least one first radio base station (RU), in which a communication link between the radio base station (RU) or one of the radio base stations (RU) and a terminal (IUE) is set up and the terminal (IUE) is used and configured as an additional second radio base station (rRU).

In some embodiments, the second radio base station is configured such that it does not query and/or request any different or additional access credentials and/or authentication information or logon information than the first radio base station queries and/or requests from terminals for use of the second radio base station.

In some embodiments, the terminal (IUE) is used as an additional second radio base station (rRU) that is configured to communicate using two or more communication protocols.

In some embodiments, the at least one first radio base station (RU) is designed to communicate in accordance with the 3GPP standard.

In some embodiments, the additional second radio base station (rRU) is designed to convey communication links between two or more terminals (AUE).

In some embodiments, the additional second radio base station (rRU) is designed to convey communication links between at least one terminal (AUE) and a cloud of the edge cloud system.

In some embodiments, the wireless industrial edge cloud system is a manufacturing system and/or a maintenance system and/or a logistics system.

In some embodiments, the second radio base station is configured such that it does not query and/or request any different or additional access credentials and/or authentication information or logon information than the first radio base station queries and/or requests from terminals for use of the second radio base station. For further terminals, the communication with the second radio base station thus does not differ from the communication with the first radio base station of the industrial edge cloud system.

In some embodiments, the terminal is configured, as a second radio base station, such that it uses one or more other communication channels to communicate with further terminals than it does to communicate with the first radio base station. In this development, further terminals do not have to share the communication channel that the second radio base station uses to communicate with the first radio base station in order to communicate with the second radio base station, but rather are able to use their own communication channel in unshared and thus unrestricted form.

As another example, some embodiments include a radio base station, designed to participate in one or more of the methods as described herein as a first base station (RU), designed to set up a communication link to a terminal (IUE) and to use and configure the terminal (IUE) as an additional second radio base station (rRU).

In some embodiments, the radio base station is designed to convey communication links between the second radio base station (rRU) and the cloud by way of the communication link.

As another example, some embodiments include a terminal designed to participate in one or more of the methods described herein, configured to create a communication link with a first base station (RU) of a wireless industrial edge cloud system and designed to take on a function as an additional second radio base station (rRU) and to convey further communication links of this function via the communication link with the first base station (RU) of the wireless industrial edge cloud system.

In some embodiments, the communication link of the function comprises a communication link to a cloud of the wireless industrial edge cloud system.

In some embodiments, the terminal comprises a manufacturing device and/or a maintenance device and/or a logistics device.

In some embodiments, the terminal is configured such that, when it takes on the function as a second radio base station, it does not query and/or request any different or additional access credentials and/or authentication information or logon information than the first radio base station queries and/or requests from further terminals. The communication with the second radio base station thus does not differ from the communication with the first radio base station of the industrial edge cloud system for further terminals.

In some embodiments, the terminal is configured such that it uses one or more other communication channels to communicate with further terminals than it does to communicate with the first radio base station. In this development, further terminals do not have to share the communication channel that the second radio base station uses to communicate with the first radio base station in order to communicate with the second radio base station, but rather may use their own radio communication channel in unshared and thus unrestricted form.

### BRIEF DESCRIPTION OF THE DRAWING

The teaching of the present disclosure are explained in more detail below with reference to an example embodiment that is illustrated in the Single Figure.

### DETAILED DESCRIPTION

In the methods described herein for operating a wireless industrial edge cloud system comprising at least one first radio base station, a communication link between the at least one first radio base station or at least one of the radio base stations and a terminal is set up, and the terminal is used and configured as an additional second radio base station. This enables dual use of a mobile communication technology such as in particular 5G or 6G both to carry out backbone communication of the terminal and for user and/or application communication for further terminals on the basis of existing user communication concepts and technologies of the mobile communication stack, by incorporating a terminal as an additional second radio base station. For this purpose, the terminal is used as described above.

In some embodiments, the method may enable a recursive extension of the coverage of a wireless communication system by virtue of remote terminals being connected step-by-step as respective second radio base stations using on-board radio technology. It is not necessary to coordinate different communication technologies with one another, since the basic communication technique used for communication between terminals and the base system is able to be used to create a second radio base station itself. There is thus no need for any seamless bridges between different technologies. It is not necessary to provide mobile further radio base stations or to connect these to the backbone infrastructure using different communication technologies. The method may additionally be used flexibly in different ambient conditions, for instance regardless of the weather, the state of newly built components and regardless of supply chains.

The further second radio base stations are able to work autonomously with a considerably reduced risk of failure, for instance caused by damage to cables. This also considerably increases flexibility, and complexity and costs are reduced at the same time. This may prove to be particularly useful during use in the field, such as in construction sites that are constantly being formed in new spaces.

The methods described herein result in reduced system complexity for an industrial edge cloud system, since the application communication, on the one hand, and the infrastructure communication, on the other hand, are based on the same technology stack.

Configuration as an additional second radio base station means that the terminal is able to communicate with further terminals as an additional second radio base station. In some embodiments, the second radio base station is configured such that it does not query and/or request any different or additional access credentials and/or authentication information or logon information than the first radio base station queries and/or requests from terminals for use of the second radio base station. For further terminals, the communication with the second radio base station thus does not differ from the communication with the first radio base station of the industrial edge cloud system.

In some embodiments, the terminal is configured as a second radio base station, such that it uses one or more other communication channels to communicate with further terminals than it does to communicate with the first radio base station. Further terminals do not have to share the communication channel that the second radio base station uses to communicate with the first radio base station in order to communicate with the second radio base station, but rather are able to use their own communication channel in unshared and thus unrestricted form.

In some embodiments, all terminals that have the hardware functions required to implement a second radio base station, such as in particular computing resources or radio communication means, may be configured as an additional second radio base station. Edge cloud systems are thereby able to be scaled easily. There is no need for special hardware to implement further radio base stations, but rather terminals equipped with appropriate hardware resources may in principle be configured and used as further radio base stations by way of an appropriate configuration and appropriate software. In some embodiments, the industrial edge cloud systems may also be used autonomously, for instance using solar-operated or battery-operated terminals.

In some embodiments, the method is accordingly computer-implemented, that is to say configuring the terminal as an additional second radio base station is carried out by way of appropriate installation and/or configuration and/or launching of software on the terminal in question. In some embodiments, the terminal is also used as an additional second radio base station by way of a software-based communication protocol.

The methods may be scaled by way of a cascaded application, provided there is enough technical and physical communication bandwidth. The teaching are explained in more detail below with reference to an example embodiment that is illustrated in the drawing.

In some embodiments, the terminal is used as a second radio base station that is configured to communicate using two or more communication protocols. In this development, the second radio base station serves not just to apply a single communication protocol, but rather the additional second radio base station is able to take on all tasks of conventional radio base stations.

In some embodiments, the first and/or second radio base station is designed to communicate in accordance with the 3GPP standard.

In some embodiments, the second radio base station is appropriately designed to convey communication links between two or more terminals. The second radio base station thereby not only forms an uplink for further additional terminals, but rather the second radio base station forms a comprehensive provider for all communication links for further terminals.

In some embodiments, the second radio base station is designed to convey communication links between at least one terminal connected to the second radio base station and a cloud of the edge cloud system. In this development, the further terminals that are connected to the second radio base station may connect to the cloud simply by way of the second radio base station and thus form an edge cloud system.

In some embodiments, the wireless industrial edge cloud system is a manufacturing system and/or a maintenance system and/or a logistics system. The flexibility and uncomplicated expandability provided by the method according to the invention is particularly advantageous in particular in the abovementioned industrial application cases.

In some embodiments, the terminal is used as a second radio base station such that the second radio base station itself sets up its own radio cell.

In some embodiments, the second radio base station in this case makes available at least its own frequency for communication with further terminals, said frequency differing from the frequency or frequencies with which the second radio base station is in a communication connection with the first radio base station.

In some embodiments, the terminal is used as a second radio base station such that the second radio base station uses at least one further channel access procedure to communicate with further terminals, said further channel access procedure being different from the channel access procedures used by communication links between the first radio base station and the second radio base station and communication links between the first radio base station and further terminals.

In some embodiments, the terminal is used as a second radio base station such that the second radio base station uses a further authentication procedure to communicate with further terminals, said further authentication procedure being different from the authentication procedures used by communication links between the first radio base station and the second radio base station and communication links between the first radio base station and further terminals.

In some embodiments, slicing, which is established in 5G and/or 6G, is used to separate communication links between the first radio base station and the second radio base station, on the one hand, and the second radio base station and further terminals, on the other hand.

The abovementioned developments may make it possible to minimize mutual influencing of the communication between the first radio base station and the second radio base station, on the one hand, and the second radio base station and further terminals, on the other hand.

In some embodiments, the terminal, which is used as a second radio base station, on the one hand, continues to be operated as a terminal. In this development, the terminal thus takes on not only the function of the second radio base station, but also continues to function as a terminal with functions different from the function of the second radio base station.

In some embodiments, the terminal is used as a second radio base station such that the second radio base station uses core functionalities of the first radio base station, in particular the one or more SMO functions and/or the one or more CORE functions.

In some embodiments, the configuration of the terminal is defined using, in particular by, the first radio base station while this terminal is being used as a second radio base station.

In some embodiments, the communication link between the first radio base station and second radio base station is expediently kept transparent for terminals that connect to the second radio base station.

The radio base station is designed to participate in a method as described above as a first radio base station. The first radio base station is designed to set up a communication link with a terminal and to use and configure the terminal as an additional second radio base station. The first radio base station is designed to carry out authentication and/or provisioning and/or configuration of the terminal as a second radio base station.

In some embodiments, the radio base station is designed, as a first radio base station, to convey communication links between the second radio base station and the cloud by way of the communication link. The first radio base station thus provides the functionalities for the terminal operating as second radio base station.

The terminal is designed and configured to participate in a method as described above. The terminal is configured and designed to create a communication link with a first radio base station of a wireless industrial edge cloud system, to take on a function as a further second radio base station and to convey further communication links of this function via the communication link to the first radio base station of the wireless industrial edge cloud system.

In some embodiments, the terminal is configured such that, when it takes on the function as a second radio base station, it does not query and/or request any different or additional access credentials and/or authentication information or logon information than the first radio base station queries and/or requests from further terminals. The communication with the second radio base station thus does not differ from the communication with the first radio base station of the industrial edge cloud system for further terminals.

In some embodiments, the terminal is configured such that it uses one or more other communication channels to communicate with further terminals than it does to communicate with the first radio base station. In this development, further terminals do not have to share the communication channel that the second radio base station uses to communicate with the first radio base station in order to communicate with the second radio base station, but rather may use their own communication channel in unshared and thus unrestricted form.

In some embodiments, the communication link of the function comprises a communication link to a cloud of the wireless industrial edge cloud system.

In some embodiments, the terminal is or comprises a manufacturing device and/or a maintenance device and/or a logistics device.

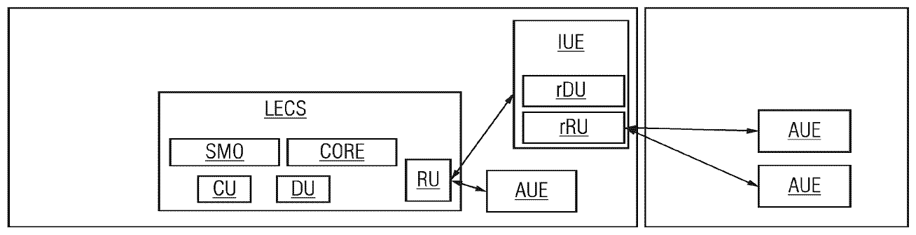

FIG. 1 shows a basic sketch of a wireless industrial edge cloud system comprising one example of a radio base station incorporating teachings of the present disclosure and one embodiment of a terminal for implementing an example method incorporating teachings of the present disclosure. A wireless industrial edge cloud system is operated in the exemplary embodiment shown. This industrial edge cloud system, in the illustrated exemplary embodiment, is a manufacturing system. In further exemplary embodiments that are not illustrated separately, the industrial edge cloud system may also be a maintenance system or a logistics system.

In the illustrated edge cloud system, a deployed mobile communication technology of the edge cloud system, here 5G, is used both to carry out backbone communication and for user/application communication on the basis of existing user communications concepts and technologies of mobile communication systems. In principle, in further exemplary embodiments that are not illustrated separately, the communication technology may also be a 6G technology or another mobile communication technology.

In order to perform the method according to the invention, in the illustrated exemplary embodiment, a new system component, referred to here as infrastructure terminal IUE, is used.

The illustrated industrial edge cloud system comprises a standard 5G system infrastructure LECS and is compliant with the 3GPP standard. The standard 5G system infrastructure LECS may be also be referred to as a basic 5G system and supports defined resource allocations, including guarantees for a quality of service, for instance for slices in 5G systems, and is configured for communication with terminals AUE and infrastructure terminals IUE as explained below.

The industrial edge cloud system is configured so as to enable communication links to infrastructure components of the standard 5G system infrastructure LECS, for example by way of what is known as slicing, with a number of defined quality criteria. Such infrastructure components comprise, in a manner known per se, service management/orchestration devices SMO, underlying basic devices CORE and centralized units, CU, and distributed units or decentralized units, DU. These infrastructure components may also be referred to as backbone components. The infrastructure components represent the internal radio access network components of the standard 5G system infrastructure LECS.

The standard 5G system infrastructure LECS furthermore comprises radio base stations RU that are communicatively connected directly to the standard 5G system infrastructure LECS and that enable the infrastructure components to have communication links to one another and also to terminals AUE not belonging to the standard 5G system infrastructure and the cloud, on the one hand. On the other hand, these radio base stations RU also enable terminals AUE that do not belong to the infrastructure components of the standard 5G system infrastructure LECS to have communication links to one another and to the cloud by way of the standard 5G system infrastructure LECS. These radio base stations RU may use different frequencies for communication with terminals AUE and infrastructure terminals IUE as described below.

It is not just the terminals AUE and the standard 5G system infrastructure LECS that are part of the illustrated industrial edge cloud system, however. A special group of terminals is added, these being referred to as infrastructure terminals IUE.

These infrastructure terminals IUE are designed and configured to set up communication links with the standard 5G system structure LECS such that the infrastructure terminals IUE provide backbone communication links to further terminals AUE.

The infrastructure terminals IUE communicate with the standard 5G system infrastructure LECS, that is to say the local 5G communication system, via a defined resource allocation, for example by way of 5G slices, in order to connect the infrastructure terminals IUE to the local standard 5G system infrastructure LECS.

The infrastructure terminals IUE themselves likewise have infrastructure components, such as distributed units rDU of the infrastructure terminal IUE. The infrastructure terminals IUE additionally also each comprise at least their own remote radio module rRU. The distributed units rDU of the infrastructure terminals IUE manage and operate the remote radio modules rRU of the infrastructure terminals IUE.

The infrastructure terminals IUE connect themselves to the core components of the standard 5G system infrastructure LECS using their own remote radio modules rRU and thereby set up backbone communication links for user traffic, signaling and management for further terminals AUE.

Based on this backbone communication with the standard 5G system infrastructure LECS, the infrastructure terminals IUE additionally offer communication links to further terminals AUE by way of their own remote radio modules rRU, these not normally lying within the area of coverage of the radio base stations RU connected to the standard 5G system infrastructure LECS.

The further terminals aue constitute conventional “normal” terminals, for example an industrial hand-held device or an industrial 5G router. It is used for communication between user application endpoints on other UEs or in a backend system.

The remote radio modules rRU of the infrastructure terminals IUE offer radio access to further terminals AUE without causing unwanted interference on their own radio communication link to the standard 5G system infrastructure LECS.

It is thus possible to extend the range of local communication through efficient reuse of the existing (same) communication technology—without the need for seamless integration of different technologies.

What is claimed is:

1. A method for operating a wireless industrial edge cloud system with a first radio base station, the method comprising:
setting up a communication link between the first radio base station and a terminal; and using the terminal as an additional second radio base station.

2. The method as claimed in claim 1, wherein the second radio base station does not query and/or request any different or additional access credentials and/or authentication information or logon information than the first radio base station queries and/or requests from terminals for use of the second radio base station.

3. The method as claimed in claim 2, wherein the terminal is configured to communicate using two or more communication protocols.

4. The method as claimed in claim 1, wherein the first radio base station communicates in accordance with a 3GPP standard.

5. The method as claimed in claim 1, wherein the terminal conveys communication links between two or more additional terminals.

6. The method as claimed in claim 1, terminal conveys communication links between an additional terminal and a cloud of the edge cloud system.

7. The method as claimed in claim 1, wherein the wireless industrial edge cloud system comprises: a manufacturing system, a maintenance system, and/or a logistics system.

8. The method as claimed in claim 1, wherein the terminal does not query and/or request any different or additional access credentials and/or authentication information or logon information than the first radio base station queries and/or requests from terminals for use of the second radio base station.

9. The method as claimed in claim 1, wherein the terminal uses one or more other communication channels to communicate with further terminals than it does to communicate with the first radio base station.

10-16. (canceled)
